(19) United States
(12) Patent Application Publication
(10) Pub. No.: US 2026/0193452 A1
(43) Pub. Date: Jul. 9, 2026

(54) VIBRATION ISOLATION RUBBER COMPOSITION AND VIBRATION ISOLATION RUBBER MEMBER

(71) Applicant: Sumitomo Riko Company Limited, Aichi (JP)

(72) Inventors: Yuko MATSUSHITA, Aichi (JP); Toyohisa TOHYAMA, Aichi (JP); Seiji KASAI, Aichi (JP)

(73) Assignee: Sumitomo Riko Company Limited, Aichi (JP)

(21) Appl. No.: 19/554,375

(22) Filed: Mar. 2, 2026

Related U.S. Application Data
(63) Continuation of application No. PCT/JP2024/033001, filed on Sep. 16, 2024.

(30) Foreign Application Priority Data
Sep. 27, 2023 (JP) 2023-164218

(51) Int. Cl. C08L 7/00; C08K 3/04; C08K 3/06; C08K 3/22; C08K 3/24; C08K 5/00; C08K 5/17

(52) U.S. Cl. CPC C08L 7/00; C08K 3/04; C08K 3/06; C08K 3/22; C08K 3/24; C08K 5/0025; C08K 5/17; C08K 2003/2296; C08L 2203/20

(57) ABSTRACT

Provided are a vibration isolation rubber composition and a vibration isolation rubber member that achieve both low dynamic magnification and durability. The vibration isolation rubber composition contains components (A) to (C) below, wherein the total amount of component (B) and component (C) is 20 parts by mass or more and 70 parts by mass or less with respect to 100 parts by mass of component (A), and the ratio of component (B) to the total amount of component (B) and component (C) is 50% by mass or more and 90% 10 by mass or less. The vibration isolation rubber member includes the vibration isolation rubber composition. (A) Diene rubber, (B) surface-activated carbon black having an amount of generated hydrogen having a value (Hc) of 4500 ppm or more per one gram carbon black heated to 1980° C., (C) HAF-grade carbon black.

### RELATED APPLICATIONS

This application is a continuation of International Application No. PCT/JP2024/033001, filed on Sep. 16, 2024, which claims priority to JP 2023-164218 which was filed on Sep. 27, 2023, the entire contents of each of which are herein incorporated by reference.

### TECHNICAL FIELD

The present disclosure relates to a vibration isolation rubber composition and a vibration isolation rubber member, and more particularly to a vibration isolation rubber composition and a vibration isolation rubber member suitable for vibration isolation rubbers for vehicles such as automobiles.

### BACKGROUND ART

Vibration isolation rubber compositions are used in automobiles to reduce vibration and noise. For such a vibration isolation rubber composition, there is a demand for reduction of a value of dynamic magnification [dynamic spring constant (Kd100)/static spring constant (Ks)] (low dynamic magnification) because a vulcanized body of the vibration isolation rubber composition (vibration isolation rubber member) requires high rigidity, high strength, and suppression of vibration transmission. Conventionally, low dynamic magnification is addressed, for example, by using carbon black as a reinforcing agent in a vibration isolation rubber composition and controlling factors such as the amount of carbon black blended, particle size, and structure.

### RELATED ART DOCUMENT

### Patent Document

JP-B-7037986

### SUMMARY

### Problems to be Solved by the Disclosure

Vibration isolation members for automobiles are also required to be durable, that is, their vibration-isolating performance and support rigidity remain unchanged over long periods of use. Carbon black with a large iodine adsorption amount has the effect of improving durability, but this is a trade-off with poor dynamic magnification.

An object of the present disclosure is to provide a vibration isolation rubber composition and a vibration isolation rubber member that achieve both low dynamic magnification and durability.

### Means for Solving the Problems

In order to achieve the object, a vibration isolation rubber composition according to the present disclosure comprises components (A) to (C) below, wherein a total amount of component (B) and component (C) is 20 parts by mass or more and 70 parts by mass or less with respect to 100 parts by mass of component (A), and a ratio of component (B) to the total amount of component (B) and component (C) is 50% by mass or more and 90% by mass or less,
(A) diene rubber,
(B) surface-activated carbon black having an amount of generated hydrogen having a value (Hc) of 4500 ppm or more per one gram carbon black heated to 1980° C., and
(C) HAF-grade carbon black.

The total amount of component (B) and component (C) may be 30 parts by mass or more and 50 parts by mass or less with respect to 100 parts by mass of component (A). The ratio of component (B) to the total amount of component (B) and component (C) may be 60% by mass or more and 80% by mass or less. The iodine adsorption amount of component (C) may be 50 g/kg or more.

A vibration isolation rubber member according to the present disclosure includes a vulcanized body of the vibration isolation rubber composition according to the present disclosure.

The vibration isolation rubber member according to the present disclosure may be suitably used for electric vehicles.
(1) A vibration isolation rubber composition according to the present disclosure comprises components (A) to (C) below, wherein a total amount of the component (B) and the component (C) is 20 parts by mass or more and 70 parts by mass or less with respect to 100 parts by mass of the component (A), and a ratio of the component (B) to the total amount of the component (B) and the component (C) is 50% by mass or more and 90% by mass or less,
(A) diene rubber,
(B) surface-activated carbon black having an amount of generated hydrogen having a value (Hc) of 4500 ppm or more per one gram carbon black heated to 1980° C., and
(C) HAF-grade carbon black.
(2) In the vibration isolation rubber composition according to (1) above, the total amount of the component (B) and the component (C) may be 30 parts by mass or more and 50 parts by mass or less with respect to 100 parts by mass of the component (A).
(3) In the vibration isolation rubber composition according to (1) or (2) above, the ratio of the component (B) to the total amount of the component (B) and the component (C) may be 60% by mass or more and 80% by mass or less.
(4) In the vibration isolation rubber composition according to any one of (1) to (3) above, the component (C) may have an iodine adsorption amount of 50 g/kg or more.
(5) A vibration isolation rubber member according to the present disclosure comprises a vulcanized body of the vibration isolation rubber composition according to any one of (1) to (4) above.
(6) In the vibration isolation rubber member according to (5) above, the vibration isolation rubber member according to the present disclosure may be for electric vehicles.

### Effects of the Disclosure

The vibration isolation rubber composition according to the present disclosure contains components (A) to (C) and includes component (B) and component (C) in a particular ratio, thereby achieving both low dynamic magnification and durability.

Here, when the total amount of component (B) and component (C) is 30 parts by mass or more and 50 parts by mass or less with respect to 100 parts by mass of component (A), the effect of improving durability is excellent. In addition, low dynamic magnification is facilitated.

When the ratio of component (B) to the total amount of component (B) and component (C) is 60% by mass or more and 80% by mass or less, the effect of improving durability is excellent. In addition, low dynamic magnification is facilitated.

When the iodine adsorption amount of component (C) is 50 g/kg or more, the effect of improving durability is excellent.

The vibration isolation rubber member according to the present disclosure includes a vulcanized body of the vibration isolation rubber composition according to the present disclosure, thereby achieving both low dynamic magnification and durability.

The vibration isolation rubber member according to the present disclosure may be suitably used for electric vehicles.

### BRIEF DESCRIPTION OF DRAWINGS

FIG. 1 is a scatter chart of dynamic magnification (spring characteristic) relative to hardness with data from examples and comparative examples.

FIG. 2 is a scatter chart of durability relative to hardness with data from examples and comparative examples.

### EMBODIMENTS OF THE DISCLOSURE

A vibration isolation rubber composition and a vibration isolation rubber member according to the present disclosure will be described in detail below.

A vibration isolation rubber composition according to the present disclosure (which hereinafter may be simply referred to as the present vibration isolation rubber composition) contains components (A) to (C) below and includes component (B) and component (C) in a particular ratio.
(A) Diene rubber
(B) Surface-activated carbon black having an amount of generated hydrogen having a value (Hc) of 4500 ppm or more per one gram carbon black heated to 1980° C., and
(C) HAF-grade carbon black.

Diene rubber (A) is a main component of rubber components in the vibration isolation rubber composition. The main component of rubber components refers to a component that accounts for 50% by mass or more of the total rubber components in the vibration isolation rubber composition. The vibration isolation rubber composition is greatly affected by the properties of diene rubber (A), which is the main component of rubber components. Examples of diene rubber (A) include natural rubber (NR), butadiene rubber (BR), styrene-butadiene rubber (SBR), chloroprene rubber (CR), isoprene rubber (IR), and acrylonitrile-butadiene rubber (NBR). These may be used alone or in combination of two or more as diene rubber (A). Among these, natural rubber is preferably used from the viewpoint of achieving all of strength, durability, and low dynamic magnification.

Surface-activated carbon black (B) has a high reinforcing effect and has the effect of maintaining spring characteristics without impairing the dynamic magnification of the vibration isolation rubber composition. When component (B) is heated to 1980° C., hydrogen is generated. The amount of the generated hydrogen (a value (Hc)) is 4500 ppm per one gram of carbon black subjected to heating at 1980° C. Hc of 5000 ppm or more is preferable because excellent surface activity is achieved. The amount of hydrogen is derived from hydrogen atoms of organic groups covalently bonded to carbon atoms of carbon black, such as hydroxyl group and carboxy group.

For example, the amount of hydrogen is measured as follows. First, 20 mg of carbon black, dried in advance at 125° C. for four hours in a vacuum dryer to remove an adsorption component of carbon black, is placed in a tin capsule and subjected to pyrolysis at 1980° C. for 70 seconds in a graphite crucible using a high-sensitivity hydrogen analyzer (EMGA-621 manufactured by HORIBA, Ltd. using a TCD detector). The generated gas is passed through a high-temperature oxidizing agent, a normal-temperature oxidizing agent, a decarbonizing agent, and a desiccant by a carrier gas (inert argon gas) with a constant flow rate (400 ml/min), and separated by a column. The resulting hydrogen gas is then quantified by a detector (thermal conductivity method).

One type of surface-activated carbon black (B) may be used alone or two or more types may be used in combination as long as the amount of hydrogen is as described above.

Surface-activated carbon black (B) preferably has an iodine adsorption amount of 14 g/kg or more and 28 g/kg or less from the viewpoint of durability and low dynamic magnification. The iodine adsorption amount of carbon black is measured according to JIS K 6217-1 (method A). Surface-activated carbon black (B) preferably has a Dibutyl Phthalate (DBP) absorption amount of 118 ml/100 g or more and 132 ml/100 g or less from the viewpoint of durability and low dynamic magnification. The DBP absorption amount of carbon black is measured according to JIS K 6217-4.

High Abrasion Furnace (HAF)-grade carbon black (C) is a high wear-resistant furnace carbon black, which is classified in the N300 series by ASTM D1765. HAF-grade carbon black (C) preferably has an iodine adsorption amount of 50 g/kg or more from the viewpoint of durability and low dynamic magnification. The iodine adsorption amount is more preferably 50 g/kg or more and 100 g/kg or less, and even more preferably 60 g/kg or more and 90 g/kg or less. HAF-grade carbon black (C) preferably has a DBP absorption amount of 50 ml/100 g or more and 110 ml/100 g or less from the viewpoint of durability and low dynamic magnification.

HAF-grade carbon black (C) is a carbon black with a large iodine adsorption amount. The use of HAF-grade carbon black (C) improves durability. On the other hand, the dynamic magnification deteriorates. For this reason, when HAF-grade carbon black (C) is used alone, it is impossible to achieve both low dynamic magnification and durability. Surface-activated carbon black (B) has a high reinforcing effect and has the effect of maintaining spring characteristics without impairing the dynamic magnification of the vibration isolation rubber composition. When surface-activated carbon black (B) is used together with HAF-grade carbon black (C), it is possible to achieve both low dynamic magnification and durability.

The total amount of component (B) and component (C) is 20 parts by mass or more and 70 parts by mass or less with respect to 100 parts by mass of component (A). If the total amount of component (B) and component (C) is too small, the reinforcing effect is small, the rigidity (static spring constant) is low, and the durability is low. If the total amount of component (B) and component (C) is too large, the rigidity is high, but the durability is low. In addition, the dynamic magnification deteriorates. When the total amount of component (B) and component (C) is within the above range, it is possible to achieve both low dynamic magnification and durability. From the viewpoint of achieving the excellent effect of improving durability, facilitating low dynamic magnification, and the like, the total amount of component (B) and component (C) is more preferably 25 parts by mass or more and 60 parts by mass or less, even more preferably 30 parts by mass or more and 50 parts by mass or less, with respect to 100 parts by mass of component (A).

The ratio of component (B) to the total amount of component (B) and component (C) is 50% by mass or more and 90% by mass or less. If the ratio of component (B) is too low, the spring characteristics are poor and the dynamic magnification deteriorates. If the ratio of component (B) is too high, the durability fails to be satisfied. When the ratio of component (B) is within the above range, it is possible to achieve both low dynamic magnification and durability. From the viewpoint of achieving the excellent effect of improving durability, facilitating low dynamic magnification, and the like, the ratio of component (B) to the total amount of component (B) and component (C) is more preferably 55% by mass or more and 85% by mass or less, even more preferably 60% by mass or more and 80% by mass or less.

From the viewpoint of facilitating low dynamic magnification and the like, the content of component (B) is preferably 10 parts by mass or more, more preferably 12.5 parts by mass or more, even more preferably 15 parts by mass or more, with respect to 100 parts by mass of component (A). From the viewpoint of ensuring the content of component (C), the excellent effect of improving durability, and the like, the content of component (B) is preferably 63 parts by mass or less, more preferably 54 parts by mass or less, even more preferably 45 parts by mass or less, with respect to 100 parts by mass of component (A).

From the viewpoint of achieving the excellent effect of improving durability and the like, the content of component (C) is preferably 2 parts by mass or more, more preferably 2.5 parts by mass or more, even more preferably 3 parts by mass or more, with respect to 100 parts by mass of component (A). From the viewpoint of ensuring the content of component (B) and facilitating low dynamic magnification, and the like, the content of component (C) is preferably 35 parts by mass or less, more preferably 30 parts by mass or less, even more preferably 25 parts by mass or less, with respect to 100 parts by mass of component (A).

The vibration isolation rubber composition according to the present disclosure may contain an additive and the like as appropriate in addition to components (A) to (C). Examples of the additive and the like include a vulcanizing agent, a vulcanization accelerator, a vulcanization aid, an antioxidant, and a process oil.

Examples of the vulcanizing agent include sulfur (powder sulfur, precipitated sulfur, insoluble sulfur) and sulfur-containing compounds such as alkylphenol disulfide. These may be used alone or in combination of two or more. Sulfur is more preferred.

The content of the vulcanizing agent is preferably in the range of 0.1 to 10 parts by mass, particularly preferably in the range of 0.3 to 5 parts by mass, with respect to 100 parts by mass of diene rubber (A). If the content of the vulcanizing agent is too low, the crosslinking reactivity tends to deteriorate. If the content of the vulcanizing agent is too high, rubber properties (breaking strength, breaking elongation) tend to decrease.

When sulfur is used as a vulcanizing agent, the sulfur content is preferably in the range of 1 to 2.5 parts by mass with respect to 100 parts by mass of diene rubber (A). The sulfur content is more preferably in the range of 1.5 to 2 parts by mass. When the sulfur content is 1 part by mass or more, the crosslinking density is ensured and the decrease in static spring constant is suppressed. When the sulfur content is 2.5 parts by mass or less, heat resistance is excellent.

Examples of the vulcanization accelerator include thiuram, sulfenamide, guanidine, thiazole, aldehyde ammonia, aldehyde amine, and thiourea vulcanization accelerators. These may be used alone or in combination of two or more. Among these, a combination of a thiuram vulcanization accelerator and at least one selected from sulfenamide, guanidine, and thiazole vulcanization accelerators is preferred in order to achieve excellent compression set.

The content of the vulcanization accelerator is preferably in the range of 0.1 to 10 parts by mass, particularly preferably in the range of 0.3 to 5 parts by mass, with respect to 100 parts by mass of diene rubber (A).

Examples of the thiuram vulcanization accelerator include tetramethylthiuram disulfide (TMTD), tetraethylthiuram disulfide (TETD), tetrabutylthiuram disulfide (TBTD), tetrakis (2-ethylhexyl) thiuram disulfide (TOT), and tetrabenzylthiuram disulfide (TBzTD).

Examples of the sulfenamide vulcanization accelerator include N-oxydiethylene-2-benzothiazolylsulfenamide (NOBS), N-cyclohexyl-2-benzothiazolylsulfenamide (CBS), N-t-butyl-2-benzothiazolesulfenamide (BBS), and N,N′-dicyclohexyl-2-benzothiazolesulfenamide. These may be used alone or in combination of two or more.

Examples of the guanidine vulcanization accelerator include N,N′-diphenylthiourea, trimethylthiourea, N,N′-diethylthiourea, and N,N′-dibutylthiourea. These may be used alone or in combination of two or more.

Examples of the thiazole vulcanization accelerator include dibenzothiazyl disulfide (MBTS), 2-mercaptobenzothiazole (MBT), 2-mercaptobenzothiazole sodium salt (NaMBT), and 2-mercaptobenzothiazole zinc salt (ZnMBT). These may be used alone or in combination of two or more. Among these, dibenzothiazyl disulfide (MBTS) and 2-mercaptobenzothiazole (MBT) are preferred in terms of excellent crosslinking reactivity.

Examples of the vulcanization aid include zinc oxide (ZnO), stearic acid, and magnesium oxide. These may be used alone or in combination of two or more.

The content of the vulcanization aid is preferably in the range of 0.1 to 10 parts by mass, particularly preferably in the range of 0.3 to 7 parts by mass, with respect to 100 parts by mass of diene rubber (A).

Examples of the antioxidant include amine antioxidants, imidazole antioxidants, carbamate antioxidants, phenolic antioxidants, and quinoline antioxidants. These antioxidants may be used alone or in combination of two or more. The antioxidant may a combination of an amine antioxidant and an imidazole antioxidant.

The content of the antioxidant is preferably in the range of 0.5 to 15 parts by mass, particularly preferably in the range of 1 to 10 parts by mass, with respect to 100 parts by mass of diene rubber (A).

Examples of the amine antioxidant include those having diphenylamine skeletons, those having phenylenediamine skeletons, and those having dihydroquinoline skeletons. Specific examples include polymerized 2,2,4-trimethyl-1,2-dihydroquinoline, N-(1,3-dimethylbutyl)-N′-phenyl-p-phenylenediamine, 4,4′-bis(4-a, a-dimethylbenzyl)diphenylamine, and N,N′-di-β-naphthyl-p-phenylenediamine.

The ratio of the amine antioxidant blended is preferably in the range of 1 to 10 parts by mass, particularly preferably in the range of 2 to 5 parts by mass, with respect to 100 parts by mass of diene rubber (A).

Examples of the process oil include naphthene oils, paraffin oils, and aromatic oils. These may be used alone or in combination of two or more.

The content of the process oil is preferably in the range of 1 to 35 parts by mass, particularly preferably in the range of 3 to 30 parts by mass, with respect to 100 parts by mass of diene rubber (A).

The vibration isolation rubber composition according to the present disclosure may be prepared by kneading components (A) to (C) and other materials added as necessary using a kneading machine such as a kneader, a Banbury mixer, an open roll, or a twin-screw stirrer.

The vibration isolation rubber composition according to the present disclosure is vulcanized for 5 to 30 minutes at a high temperature (150 to 170° C.) into a vibration isolation rubber member (vulcanized body). The vibration isolation rubber member including the vulcanized body of the vibration isolation rubber composition according to the present disclosure may be advantageously used for vibration isolation rubber applications for automobiles, such as motor mounts, suspension bushes, and subframe mounts for engine vehicles and electric vehicles powered by electric motors (including electric vehicles (EV), fuel cell vehicles (FCV), plug-in hybrid vehicles (PHV), and hybrid vehicles (HV)).

In the vibration isolation rubber composition according to the present disclosure having the configuration as described above, since surface-activated carbon black (B) and HAF-grade carbon black (C) are blended with diene rubber (A), and component (B) and component (C) are present in a particular ratio, it is possible to achieve both low dynamic magnification and durability.

In the vibration isolation rubber composition according to the present disclosure, the static spring constant Ks is preferably 300 N/mm or more and 1000 N/mm or less, from the viewpoint of being suitable for electric vehicles, and the like. The static spring constant Ks is more preferably 400 N/mm or more and 750 N/mm or less. When the vibration isolation rubber composition according to the present disclosure has the above configuration, the static spring constant KS may be set within the above range.

Although the embodiment of the present disclosure is described above, the present disclosure is not limited to the above embodiment, and various modifications are possible within the scope that does not deviate from the subject matter of the present disclosure.

### EXAMPLES

The present disclosure will be described in detail below with examples and comparative examples.

The materials used are as follows.

### <Component A>

### Natural Rubber (NR)

### <Component B>

Surface-activated carbon black (CB): “SPHERON 5200” manufactured by Cabot Japan K.K. (Hc 5200 ppm, iodine adsorption amount 24 g/kg, DBP absorption amount 124 ml/100 g)

### <Component C>

HAF-grade carbon black (CB)<1>: “VULCAN 3D” manufactured by Cabot Japan K.K. (iodine adsorption amount 81 g/kg, DBP absorption amount 101 ml/100 g)
HAF-grade carbon black (CB)<2>: “Seast 300” manufactured by TOKAI CARBON CO., LTD. (iodine adsorption amount 86 g/kg, DBP absorption amount 75 ml/100 g)

### <Others>

Surface inactive carbon black (CB): “Seast SO” manufactured by TOKAI CARBON CO., LTD. (FEF grade) (iodine adsorption amount 44 g/kg, DBP absorption amount 115 ml/100 g)
Zinc oxide: “Zinc Oxide No. 2” manufactured by Sakai Chemical Industry Co., Ltd.
Stearic acid: “LUNAC S30” manufactured by Kao Corporation
Process oil: “SUNTHENE 4130” manufactured by JAPAN SUN OIL COMPANY, LTD.
Amine antioxidant <1>: “OZONONE 6C” manufactured by Seiko Chemical Co., Ltd.
Amine antioxidant <2>: “NONFLEX RD” manufactured by Seiko Chemical Co., Ltd.
Vulcanization accelerator <1>: “Nocceler CZ” manufactured by OUCHI SHINKO CHEMICAL INDUSTRIAL CO., LTD.
Vulcanization accelerator <2>: “Nocceler TBT” manufactured by OUCHI SHINKO CHEMICAL INDUSTRIAL CO., LTD.

### Sulfur (Vulcanizing Agent)

### Examples 1 to 5 and Comparative Examples 1 to 5

Rubber compositions were prepared by mixing the materials in the proportions listed in Table and kneading the materials using a sealed kneading machine (Banbury type) or a roll. For the prepared rubber compositions, each property was measured and evaluated according to the methods described below.

### [Hardness]

A rubber sheet with a thickness of 2 mm was prepared by press-molding and vulcanizing each rubber composition at 150° C. for 20 minutes. A JIS No. 5 dumbbell shape was punched out from this rubber sheet, and the hardness (JIS A) was measured according to JIS K 6251 using this dumbbell. In Table, each value is converted to an index, where the hardness of Example 1 is 100.

### [Static Spring Constant (Ks)]

A rubber test specimen was prepared using each rubber composition by pressing disc-shaped metal fittings (diameter 60 mm, thickness 6 mm) on the upper and lower surfaces of a rubber piece (diameter 50 mm, height 25 mm), and vulcanization-bonding the rubber piece under vulcanization conditions of 170° C. for 30 minutes. Next, the static spring constant (Ks (N/mm)) was calculated by compressing the rubber test specimen by 7 mm in the direction of the cylinder axis and reading the loads at 1.5 mm and 3.5 mm deformations from the load-deformation curve for the second compression. In Table, each value is converted to an index, where the static spring constant (Ks) of Example 1 is 100.

### [Dynamic Spring Constant (Kd100)]

The dynamic spring constant (Kd100 (N/mm)) was calculated and measured in accordance with JIS K 6394 by compressing the rubber test specimen by 2.5 mm in the direction of the cylinder axis, setting the position at the 2.5 mm compression as the center, applying constant displacement harmonic compressive vibrations with an amplitude of 0.05 mm at a frequency of 100 Hz from below, and detecting a dynamic load with a load cell set above. In Table, each value is converted to an index, where the dynamic spring constant (Kd100) of Example 1 is 100.

### [Dynamic Magnification (Kd100/Ks)]

The dynamic magnification was calculated as a value of dynamic spring constant (Kd100)/static spring constant (Ks). In Table, each value is converted to an index, where the dynamic magnification (Kd100/Ks) of Example 1 is 100.

### [Durability]

A rubber sheet with a thickness of 2 mm was prepared by press-molding (vulcanizing) each rubber composition at 150° C. for 30 minutes. A JIS No. 3 dumbbell shape was punched out from this rubber sheet, and the number of cycles was measured by performing an elongation fatigue test in accordance with JIS K 6260 using this dumbbell. In Table, each value is converted to an index, where the number of cycles of Example 1 is 100.

### [Evaluation of Spring Characteristic Relative to Hardness]

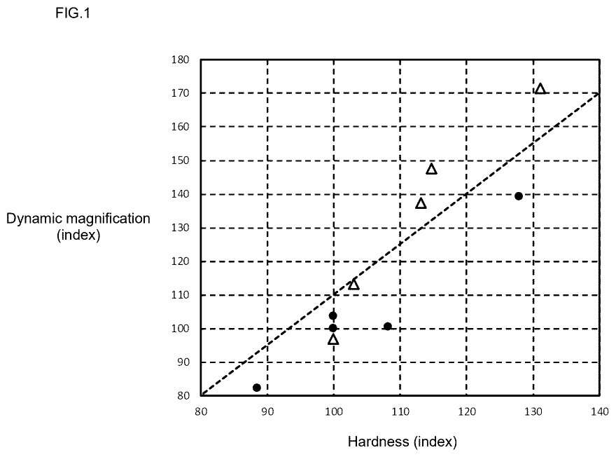

A scatter chart of FIG. 1 was created by plotting data from examples and comparative examples, where the hardness (index) is shown on the horizontal axis and the dynamic magnification (index) is shown on the vertical axis. In FIG. 1, solid circles correspond to Examples, and open triangles correspond to Comparative Examples. As can be seen in FIG. 1, the spring characteristic relative to hardness tends to increase overall. With an approximate line as a reference, in FIG. 1, those located below the line (the dotted line rising to the right in FIG. 1) were evaluated as “good” and those located above the line were evaluated as “poor.”

### [Evaluation of Durability Relative to Hardness]

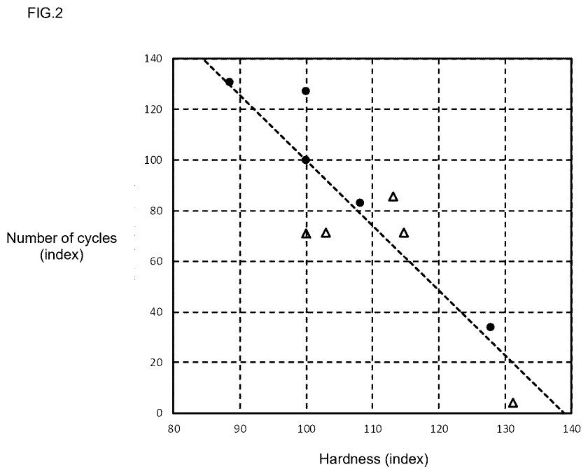

A scatter chart of FIG. 2 was created by plotting data from examples and comparative examples, where the hardness (index) is shown on the horizontal axis and the number of cycles (index) is shown on the vertical axis. In FIG. 2, solid circles correspond to Examples, and open triangles correspond to Comparative Examples. As can be seen in FIG. 2, the number of cycles relative to hardness tends to decrease overall. With an approximate line as a reference, in FIG. 2, those located above the line (the dotted line falling to the right in FIG. 2) were evaluated as “good” and those located below the line were evaluated as “poor.”

### [Overall Evaluation]

When both the spring characteristic relative to hardness and the durability relative to hardness were “good,” the test specimen was evaluated as “good.” When one of them was “poor,” the test specimen was evaluated as “poor.”

TABLE 1
(parts by mass)

| | | | Example | | | | | Comparative Example | | | | |
|---|---|---|---|---|---|---|---|---|---|---|---|---|
| | | | 1 | 2 | 3 | 4 | 5 | 1 | 2 | 3 | 4 | 5 |
| A | Natural rubber | | 100 | 100 | 100 | 100 | 100 | 100 | 100 | 100 | 100 | 100 |
| B | Surface-activated CB | SP5200 | 20 | 20 | 35 | 10 | 40 | — | — | 20 | 40 | 5 |
| C | HAF-grade CB <1> | 3D | 15 | — | 35 | 10 | 5 | 45 | 15 | — | 40 | 40 |
| | HAF-grade CB <2> | 300 | — | 15 | — | — | — | — | — | — | — | — |
| Others | Inactive CB (FEF grade) | SO | — | — | — | — | — | — | 20 | 15 | — | — |

| | | | | | | | | | | | |
|---|---|---|---|---|---|---|---|---|---|---|---|
| | Zinc oxide | 5 | 5 | 5 | 5 | 5 | 5 | 5 | 5 | 5 | 5 |
| | Stearic acid | 1 | 1 | 1 | 1 | 1 | 1 | 1 | 1 | 1 | 1 |
| | Process oil | 3 | 3 | 3 | 3 | 3 | 3 | 3 | 3 | 3 | 3 |
| | Amine antioxidant <1> | 1 | 1 | 1 | 1 | 1 | 1 | 1 | 1 | 1 | 1 |
| | Amine antioxidant <2> | 1 | 1 | 1 | 1 | 1 | 1 | 1 | 1 | 1 | 1 |
| | Vulcanization accelerator <1> | 1.2 | 1.2 | 1.2 | 1.2 | 1.2 | 1.2 | 1.2 | 1.2 | 1.2 | 1.2 |
| | Vulcanization accelerator <2> | 0.2 | 0.2 | 0.2 | 0.2 | 0.2 | 0.2 | 0.2 | 0.2 | 0.2 | 0.2 |
| | Sulfur | 2 | 2 | 2 | 2 | 2 | 2 | 2 | 2 | 2 | 2 |
| | B + C (parts by mass) | 35 | 35 | 70 | 20 | 45 | — | — | — | 80 | 45 |
| | B/(B + C) | 57% | 57% | 50% | 50% | 89% | — | — | — | 50% | 11% |
| Evaluation | Hardness (index) | 100 | 100 | 128 | 89 | 108 | 115 | 103 | 100 | 131 | 113 |
| | Static spring constant (Ks)(index) | 100 | 96 | 172 | 79 | 125 | 126 | 105 | 106 | 211 | 131 |
| | Dynamic spring constant (Kd 100)(index) | 100 | 100 | 239 | 65 | 126 | 186 | 119 | 103 | 362 | 180 |
| | Dynamic magnification (Kd 100/Ks) (index) | 100 | 104 | 139 | 82 | 101 | 147 | 113 | 97 | 172 | 137 |
| | Number of cycles (index) | 100 | 127 | 34 | 131 | 83 | 71 | 71 | 71 | 4 | 86 |
| | Evaluation of spring characteristic relative | Good | Good | Good | Good | Good | Poor | Good | Good | Poor | Poor |
| | to hardness | | | | | | | | | | |
| | Evaluation of durability relative to hardness | Good | Good | Good | Good | Good | Good | Poor | Poor | Poor | Good |
| | Overall evaluation | Good | Good | Good | Good | Good | Poor | Poor | Poor | Poor | Poor |

In Comparative Example 1, surface-activated carbon black (B) is not used for diene rubber (A), and HAF-grade carbon black (C) is used alone. In Comparative Example 1, the dynamic magnification relative to hardness is poor, and the spring characteristic is inferior. In Comparative Example 2, surface-activated carbon black (B) is not used for diene rubber (A), but instead FEF-grade carbon black is used. In other words, FEF-grade carbon black with a small iodine adsorption amount and HAF-grade carbon black (C) with a large iodine adsorption amount are used in combination. In Comparative Example 2, the durability is inferior. In Comparative Example 3, HAF-grade carbon black (C) is not used for diene rubber (A), and surface-activated carbon black (B) is used alone. In Comparative Example 3, the durability is inferior. In Comparative Example 4, surface-activated carbon black (B) and HAF-grade carbon black (C) are used in combination for diene rubber (A), but the total amount used is too large. In Comparative Example 4, the dynamic magnification relative to hardness is poor, and the spring characteristic is inferior. The durability is also inferior. In Comparative Example 5, surface-activated carbon black (B) and HAF-grade carbon black (C) are used in combination for diene rubber (A), but the amount of surface-activated carbon black (B) used is too small. In Comparative Example 5, the dynamic magnification relative to hardness is poor, and the spring characteristic is inferior.

On the other hand, in Examples, surface-activated carbon black (B) and HAF-grade carbon black (C) are blended with diene rubber (A), and component (B) and component (C) are present in a particular ratio. In Examples, the dynamic magnification relative to hardness is good, and the spring characteristic is excellent. The durability is also excellent.

Based on the above examples and comparative examples, it is understood that both low dynamic magnification and durability are achieved when surface-activated carbon black (B) and HAF-grade carbon black (C) are blended with diene rubber (A), and component (B) and component (C) are in a particular ratio.

Although the embodiments and examples of the present disclosure have been described above, the present disclosure is not limited to the above embodiments and examples, and various modifications are possible within the scope that does not deviate from the subject matter of the present disclosure.

1. A vibration isolation rubber composition comprising:
(A) diene rubber,
(B) surface-activated carbon black having an amount of generated hydrogen, denoted as a value (Hc), of 4500 ppm or more per one gram carbon black subjected to heating to 1980° C., and
(C) High Abrasion Furnace (HAF)-grade carbon black,
wherein a total amount of (B) and (C) is 20 parts by mass or more and 70 parts by mass or less with respect to 100 parts by mass of (A), and
wherein a ratio of (B) to the total amount of (B) and (C) is 50% by mass or more and 90% by mass or less.

2. The vibration isolation rubber composition according to claim 1, wherein the total amount of (B) and (C) is 30 parts by mass or more and 50 parts by mass or less with respect to 100 parts by mass of (A).

3. The vibration isolation rubber composition according to claim 1, wherein the ratio of (B) to the total amount of (B) and (C) is 60% by mass or more and 80% by mass or less.

4. The vibration isolation rubber composition according to claim 1, wherein (C) has an iodine adsorption amount of 50 g/kg or more.

5. A vibration isolation rubber member comprising a vulcanized body of the vibration isolation rubber composition according to claim 1.

6. The vibration isolation rubber member according to claim 5, wherein the vibration isolation rubber member is for electric vehicles.
